(19) United States
(12) Patent Application Publication
(10) Pub. No.: US 2021/0348546 A1
(43) Pub. Date: Nov. 11, 2021

(54) SPARK-IGNITION INTERNAL COMBUSTION ENGINE

(71) Applicant: TOYOTA JIDOSHA KABUSHIKI KAISHA, Aichi-ken (JP)

(72) Inventor: Noriyuki TAKADA, Susono-shi (JP)

(21) Appl. No.: 17/209,228

(22) Filed: Mar. 23, 2021

(30) Foreign Application Priority Data
May 11, 2020 (JP) 2020-083314

(51) Int. Cl. F02B 23/08; F02F 1/42; F02F 3/28

(52) U.S. Cl. CPC F02B 23/08; F02F 3/28; F02F 1/42

(57) ABSTRACT

A spark-ignition internal combustion engine includes a cylinder head and a piston. A crown surface of the piston includes a central portion, and first outer portions and second outer portions located outside the central portion. The central portion and the first outer portions have a combustion chamber height higher than a predetermined value. The combustion chamber height of the second outer portions is equal to or lower than the predetermined value. The crown surface is composed of a mirror surface region and a rough surface region. The mirror surface region has a surface roughness of less than 0.05 μm. The rough surface region has a surface roughness of 0.05 μm or more and 2.5 μm or less. All of the central portion and the first outer portions are included in the mirror surface region. At least one of the second outer portions is included in the rough surface region.

### CROSS-REFERENCE TO RELATED APPLICATION

This application claims priority to Japanese Patent Application No. 2020-083314 filed on May 11, 2020, incorporated herein by reference in its entirety.

### BACKGROUND

### 1. Technical Field

The present disclosure relates to a spark-ignition internal combustion engine (hereinafter, also simply referred to as an “engine”).

### 2. Description of Related Art

Japanese Unexamined Patent Application Publication No. 2018-87562 (JP 2018-87562 A) discloses a piston of a spark-ignition engine. The crown surface of a piston in the related art includes a mirror-finished region and a roughened region. The mirror-finished region is provided in the central portion of the crown surface. The arithmetic mean roughness of this region is less than 0.3 μm. The roughened region is provided along the outer circumference of the central portion. The arithmetic mean roughness of this region is 0.3 μm or more.

### SUMMARY

When the crown surface is mirror-finished, it is possible to suppress conduction of heat from the gas in the combustion chamber to the crown surface. It is thus possible to suppress the cooling loss of the engine and improve the fuel efficiency. When the crown surface is mirror-finished, it is expected that the traveling speed of the flame on the crown surface will be improved. It is thus expected that the combustion period will be shortened and the combustion efficiency will be improved, thereby further improving the fuel efficiency.

However, the present inventors confirmed through analyses a phenomenon that when the crown surface is mirror-finished, the traveling speed of the flame on the crown surface is slower than when the crown surface is not mirror-finished. It was further confirmed that this phenomenon was remarkably observed in a narrow space immediately after the occurrence of the flame. With slower traveling speed, the combustion period increases, so that the above-mentioned effect may not be sufficiently exhibited. Therefore, the present inventors have made further studies based on this new finding and has completed the present disclosure.

One object of the present disclosure is to provide a technique capable of suppressing a decrease in the traveling speed of a flame on a crown surface of a piston when a mirror-finished region is provided on the crown surface of the piston.

The present disclosure is a spark-ignition internal combustion engine and has the following features. The internal combustion engine includes a cylinder head and a piston. A crown surface of the piston includes a central portion, and first outer portions and second outer portions located outside the central portion. The central portion and the first outer portions have a combustion chamber height higher than a predetermined value. The combustion chamber height indicates a distance between the crown surface and a lower surface of the cylinder head at a top dead center during a compression stroke. The second outer portions have a combustion chamber height equal to or lower than the predetermined value. The crown surface is composed of a mirror surface region and a rough surface region. The mirror surface region has a surface roughness of less than 0.05 μm. The rough surface region has a surface roughness of 0.05 μm or more and 2.5 μm or less. All of the central portion and the first outer portions are included in the mirror surface region. At least one of the second outer portions is included in the rough surface region.

In the present disclosure, the cylinder head may include an intake port and an exhaust port. The second outer portions may be located on both sides of the central portion in an intake and exhaust direction indicating a direction from the intake port to the exhaust port. The first outer portions may be located on both sides of the central portion in a direction orthogonal to the intake and exhaust direction. All of the second outer portions may be included in the rough surface region.

In the present disclosure, the cylinder head may include an intake port and an exhaust port. The second outer portions may be located on both sides of the central portion in an intake and exhaust direction indicating a direction from the intake port to the exhaust port. The first outer portions may be located on both sides of the central portion in a direction orthogonal to the intake and exhaust direction. The second outer portion located on an intake port side may be included in the rough surface region. The second outer portion located on an exhaust port side may be included in the mirror surface region.

In the present disclosure, the internal combustion engine may further include a tumble flow generating portion that generates a tumble flow in a combustion chamber.

In the present disclosure, the predetermined value may be a value in a range of 0.9 mm to 1.5 mm.

The present inventors found out that the combustion chamber height at the top dead center during the compression stroke affects the traveling speed of the flame on the crown surface. The present disclosure has been made based on this finding. According to the present disclosure, all of the central portion and the first outer portions having a combustion chamber height higher than the predetermined value are included in the mirror surface region having a surface roughness of less than 0.05 μm. Therefore, it is possible to suppress the cooling loss of the engine on the crown surface having a combustion chamber height higher than the predetermined value. Further, according to the present disclosure, at least one of the second outer portions having a combustion chamber height equal to or lower than the predetermined value is included in the rough surface region having a surface roughness of 0.05 μm or more and 2.5 μm or less. Therefore, it is possible to suppress a decrease in the traveling speed of the flame on the crown surface having a combustion chamber height equal to or less than the predetermined value. From the above, according to the present disclosure, it is possible to improve the fuel efficiency.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic view showing a configuration example of an engine according to an embodiment;

FIG. 2 is a schematic view showing a configuration example of the engine according to the embodiment;

FIG. 3 is a schematic view showing a configuration example of a crown surface of a piston shown in FIGS. 1 and 2;

FIG. 4 is a schematic view showing a behavior of a flame immediately after the occurrence of the flame;

FIG. 5 is a diagram illustrating a combustion chamber height;

FIG. 6 is a schematic view showing a first processing example of the crown surface;

FIG. 7 is a schematic view of a combustion chamber in which a tumble flow is generated; and

FIG. 8 is a schematic view showing a second processing example of the crown surface.

### DETAILED DESCRIPTION OF EMBODIMENTS

An embodiment of the present disclosure will be described below with reference to the drawings. In the figures, the same or corresponding parts are designated by the same reference characters and description thereof will be simplified or omitted.

### 1. Configuration Example of Engine

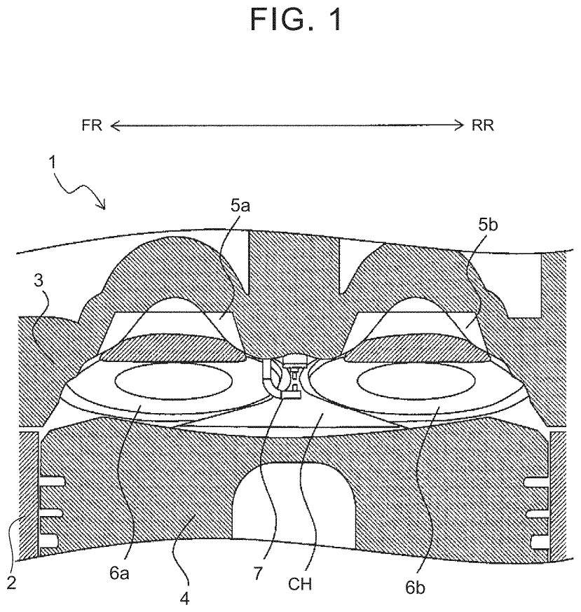

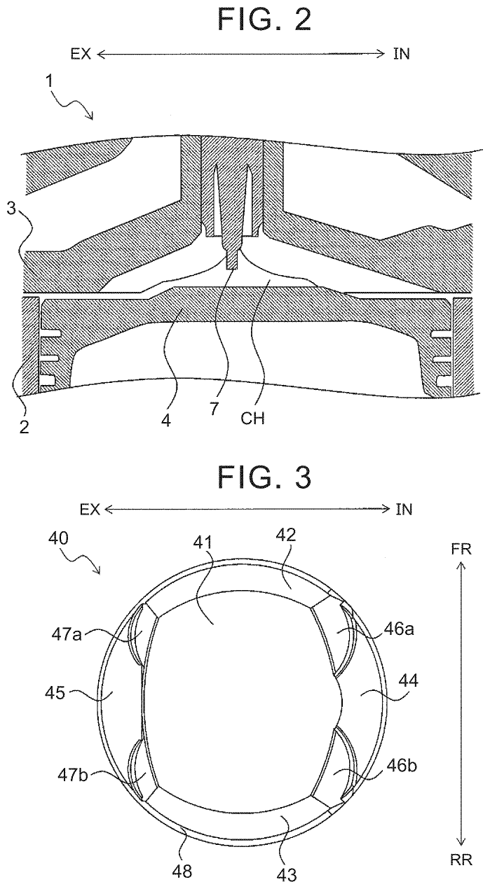

An engine according to the embodiment is preferably mounted on a vehicle. FIGS. 1 and 2 are schematic views showing configuration examples of the engine according to the embodiment. FIG. 1 corresponds to a view of a cut surface in the direction from the front FR to the rear RR of the vehicle (hereinafter, also referred to as the “FR-RR” direction) as seen from the exhaust direction EX. FIG. 2 corresponds to a view of a cut surface in the direction from the intake direction IN to the exhaust direction EX (hereinafter, also referred to as “IN-EX” direction) as seen from the rear direction RR. The FR-RR direction is orthogonal to the IN-EX direction.

The engine 1 shown in FIGS. 1 and 2 is a typical pent-roof engine. The engine 1 includes a cylinder block 2, a cylinder head 3, and a piston 4. The cylinder head 3 is provided above the cylinder block 2. The piston 4 is housed in the cylinder block 2. The side surface of the cylinder block 2, the lower surface of the cylinder head 3, and the crown surface of the piston 4 define a combustion chamber CH of the engine 1.

As shown in FIG. 1, the engine 1 includes intake ports 5a and 5b. These intake ports are provided in the cylinder block 2. The intake port 5a is provided with an intake valve 6a. The intake port 5b is provided with an intake valve 6b. Although not shown, the cylinder block 2 is provided with two exhaust ports. An exhaust valve is provided in each of these exhaust ports.

As shown in FIGS. 1 and 2, the engine 1 includes an ignition device 7. The ignition device 7 is attached to the cylinder block 2. The attachment position of the ignition device 7 is the center of the ceiling surface of the combustion chamber CH.

### 2. Configuration Example of Crown Surface of Piston

FIG. 3 is a schematic view showing a configuration example of a crown surface 40 of the piston 4 shown in FIGS. 1 and 2. As shown in FIG. 3, the crown surface 40 includes a central portion 41. First outer portions 42 and 43, second outer portions 44 and 45, and third outer portions 46a, 46b, 47a, and 47b are located outside the central portion 41. An outer edge portion 48 is located further outside these outer portions.

The central portion 41 is recessed in a dish shape. The first outer portion 42 is in contact with the central portion 41 in the forward direction FR. The first outer portion 43 is in contact with the central portion 41 in the rear direction RR. The first outer portions 42 and 43 are flat. However, the first outer portions 42 and 43 are inclined downward as they are distanced away from the central portion 41. The spaces between the first outer portions 42 and 43 and the lower surface of the cylinder head 3 are called squish areas.

The second outer portion 44 is in contact with the central portion 41 in the intake direction IN. The second outer portion 45 is in contact with the central portion 41 in the exhaust direction EX. The second outer portions 44 and 45 are flat. The second outer portions 44 and 45 are parallel to the horizontal plane. The spaces between the second outer portions 44 and 45 and the lower surface of the cylinder head 3 are also called squish areas.

The third outer portions 46a and 46b are in contact with the central portion 41 and the second outer portion 44 in the intake direction IN. The third outer portion 46a is in contact with the first outer portion 42 in the forward direction FR. The third outer portion 46a is provided to avoid interference with the intake valve 6a. The third outer portion 46b is in contact with the first outer portion 43 in the rear direction RR. The third outer portion 46b is provided to avoid interference with the intake valve 6b. The third outer portions 46a and 46b are also referred to as valve recesses. The third outer portions 46a and 46b are inclined in the same manner as the first outer portions 42 and 43.

The third outer portions 47a and 47b are in contact with the central portion 41 and the second outer portion 45 in the exhaust direction EX. The third outer portion 47a is in contact with the first outer portion 42 in the forward direction FR. The third outer portion 47b is in contact with the first outer portion 43 in the rear direction RR. The third outer portions 47a and 47b are provided to avoid interference with the two exhaust valves described above. The third outer portions 47a and 47b are also referred to as valve recesses. The third outer portions 47a and 47b are inclined in the same manner as the first outer portions 42 and 43.

The outer edge portion 48 constitutes the outer edge of the crown surface 40. The third outer portions described above may extend to the outer edge of the crown surface 40. In this case, a part of the outer edge of the crown surface 40 may be composed of the third outer portions. The outer edge portion 48 is in contact with all of the above-mentioned first to third outer portions. The outer edge portion 48 is inclined in the same manner as the first outer portion 42 and 43. However, the inclination of the outer edge portion 48 is different from those of the first outer portions 42 and 43. In the embodiment, the “inclination degree” is defined as the inclination of the constituent portions (for example, the first outer portions 42 and 43 and the outer edge portion 48) of the crown surface 40 with respect to the horizontal plane.

### 3. Features of Embodiment

### 3-1. New Findings

By performing so-called mirror-finishing that minimizes the surface roughness of the constituent surface of the combustion chamber, it is possible to reduce the amount of heat that the constituent surface receives from the gas in the combustion chamber. Thus, if the entire constituent surface of the combustion chamber is mirror-finished, it is possible to suppress the cooling loss of the engine and improve the fuel efficiency. In the embodiment, a “mirror surface” is defined as a surface having a surface roughness of less than 0.05 μm. Further, the “surface roughness” means an arithmetic mean roughness Ra. The arithmetic mean roughness Ra is measured according to Japanese Industrial Standards (JIS) B 0601: 2013.

Further, of the constituent surface of the combustion chamber, if the region to which the fuel spray supplied to the combustion chamber adheres is mirror-finished, it is possible to reduce the amount of fuel adhered in this region. Therefore, if the adhesion region of the fuel spray is mirror-finished, it is possible to suppress the generation of so-called unburned hydrocarbons (HC).

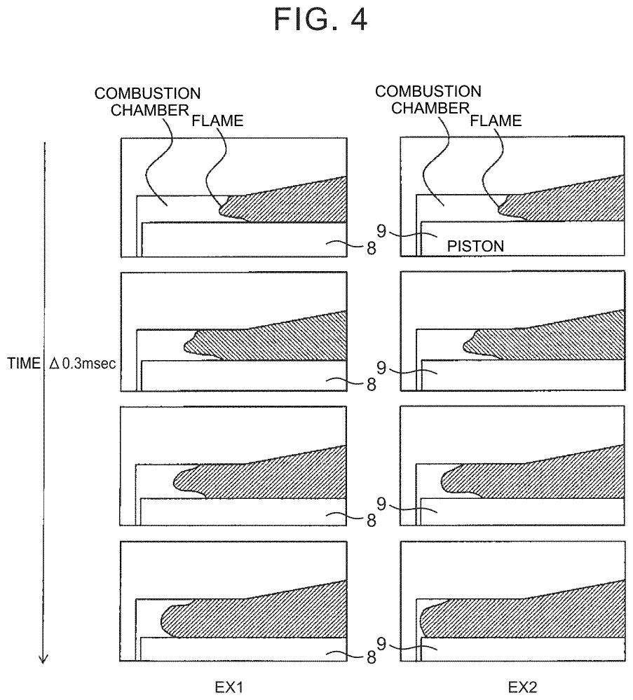

However, the present inventors revealed that the mirror surface processing at the constituent portion of the crown surface of the piston leads to another issue. The issue will be described with reference to FIG. 4. FIG. 4 is a schematic view showing the behavior of the flame immediately after the occurrence of the flame. In FIG. 4, the behavior of the flame around the squish area of two types of engines is arranged vertically. The time interval in the vertical direction is 0.3 seconds.

In Example EX1 shown on the left in FIG. 4, the entire constituent portion of the crown surface of the piston 8 is mirror-finished. On the other hand, in Example EX2 shown on the right in FIG. 4, only the central portion of the crown surface of the piston 9 is mirror-finished. That is, in Example EX2, the constituent portion of the crown surface other than the central portion is not mirror-finished. The surface roughness of the above constituent portion is 200 μm.

Comparing the behavior of the flame in Example EX1 with that of Example EX2, the following is understood. That is, in Example EX2, the flame quickly enters the narrow space generated by the lowering of the piston 9. On the other hand, in Example EX1, such a behavior of the flame is not observed. That is, the traveling speed of the flame in Example EX1 is slower than that in Example EX2. The present inventors presume that the reason for this is that since the outer portion of the crown surface of the piston 8 is mirror-finished, the turbulence in the space between the outer portion and the cylinder head is reduced.

The inventors also confirmed that the level of delay in the traveling speed is different depending on the region of the outer portion. Specifically, there was almost no delay level in the outer portions in the FR-RR direction, and therefore it was judged that the influence of the mirror surface processing was small. On the other hand, the delay level was remarkably observed in the outer portions in the IN-EX direction, and therefore a concern arose that the combustion efficiency decreases due to the extension of the combustion period. In addition, a concern arose that the unburned HC is generated around the outer portions in the IN-EX direction. The present inventors presume that this is due to the difference in the height of the space between the outer portions and the cylinder head at the top dead center during the compression stroke (hereinafter, also referred to as “combustion chamber height HCH”).

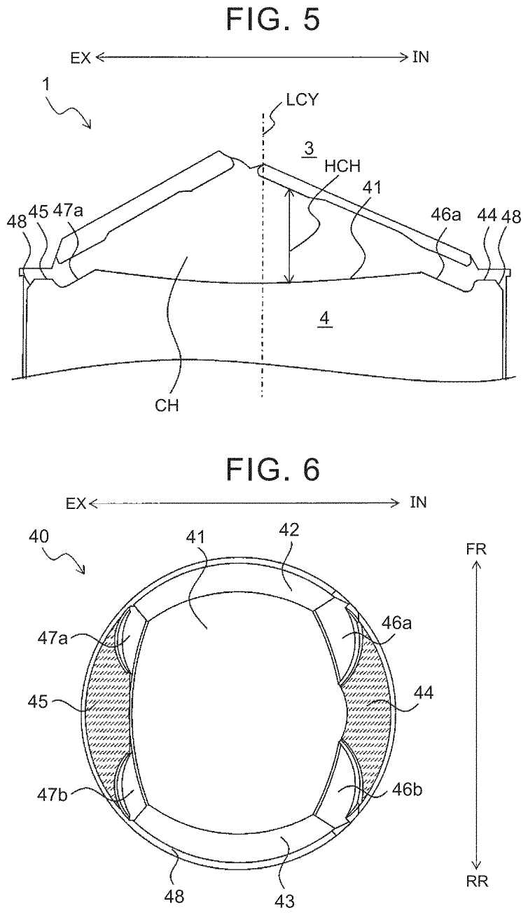

Based on the above findings, in the embodiment, the constituent portion that is not mirror-finished in the crown surface 40 is set in consideration of the combustion chamber height HCH of the constituent portion. FIG. 5 is a diagram illustrating the combustion chamber height HCH. The combustion chamber height HCH is defined as the distance between the constituent portion of the crown surface 40 and the lower surface of the cylinder head 3 in a direction parallel to the cylinder axis LCY. Since the combustion chamber height HCH at the top dead center during the compression stroke affects the delay level of the traveling speed, the combustion chamber height HCH is measured with reference to the position of the piston 4 at the top dead center during the compression stroke.

In the embodiment, a constituent portion of the crown surface 40 having a combustion chamber height HCH larger than a predetermined value is set as an option to be subjected to mirror surface processing. Further, a constituent portion of the crown surface 40 having a combustion chamber height HCH equal to or less than a predetermined value is set as an option to be subjected to rough surface processing. The “predetermined value” means a value in the range of 1.2 mm±0.3 mm (that is, 0.9 mm to 1.5 mm). The “rough surface” is defined as a surface having a surface roughness of 0.05 μm or more and 2.5 μm or less. Hereinafter, a processing example of the crown surface 40 in the embodiment will be described.

### 3-2. Processing Example of Crown Surface

### 3-2-1. First Processing Example and Its Effect

FIG. 6 is a schematic view showing a first processing example of the crown surface 40. In the first processing example, the second outer portions 44 and 45 are roughened. The second outer portions 44 and 45 have a combustion chamber height HCH equal to or less than the predetermined value. The second outer portions 44 and 45 constitute a “rough surface region” on the crown surface 40. The constituent portions other than the second outer portions 44 and 45 are mirror-finished. These constituent portions constitute a “mirror surface region” on the crown surface 40. Specifically, the mirror surface region is composed of the central portion 41, the outer edge portion 48, the first outer portions 42 and 43, and the third outer portions 46a, 46b, 47a, and 47b.

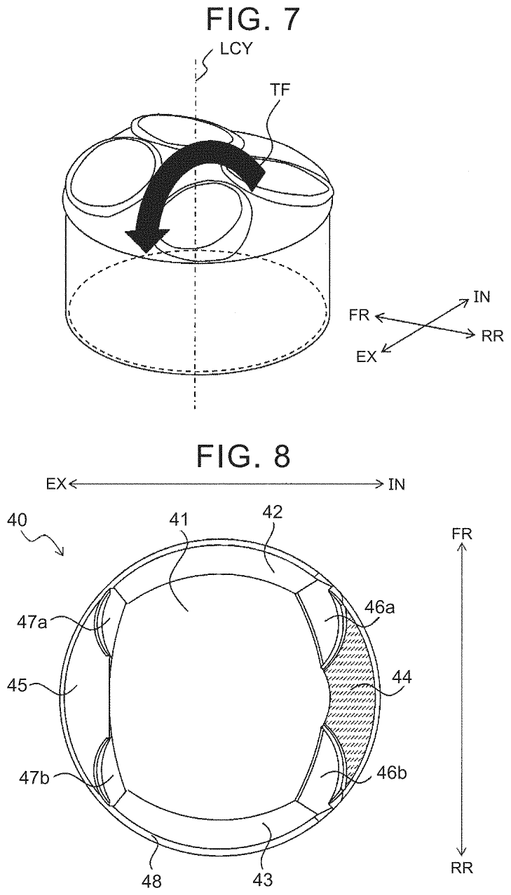

According to the first processing example, since the second outer portions 44 and 45 are roughened, it is expected that the issues associated with the mirror surface processing will be solved. Further, since the constituent portions other than the second outer portions 44 and 45 are mirror-finished, the following effect can be expected. This effect will be described with reference to FIG. 7.

FIG. 7 is a schematic view of a combustion chamber in which tumble flow is generated. The tumble flow TF shown in FIG. 7 is a so-called forward tumble flow that turns while ascending or descending in the direction of the cylinder axis LCY. The tumble flow TF is generated, for example, by controlling airflow control valves provided in the intake ports 5a and 5b. In another example, the tumble flow TF is generated when at least one of these intake ports has a shape that facilitates the generation of the tumble flow (e.g., a straight shape). Since the configuration of such a tumble flow generating portion is known, detailed description thereof will be omitted.

In the combustion chamber CH where the tumble flow TF is generated, the rough surface region may cause an unstable tumble flow TF. In this regard, in the first processing example, the rough surface region is limited to only the second outer portions 44 and 45. Therefore, it is possible to obtain the effect of mirror surface processing of the constituent portions other than the second outer portions 44 and 45 while minimizing the occurrence of an unstable tumble flow TF. The tumble flow TF may turn in the direction opposite to the direction shown in FIG. 7. That is, a so-called reverse tumble flow may occur in the combustion chamber CH.

### 3-2-2. Second Processing Example and Its Effect

FIG. 8 is a schematic view showing a second processing example of the crown surface 40. In the second processing example, only the second outer portion 44 is roughened. In the second processing example, the second outer portion 44 constitutes the rough surface region. As described above, the second outer portions 44 and 45 have a combustion chamber height HCH equal to or less than the predetermined value. However, the second outer portion 45 is included in the mirror surface region. That is, in the second processing example, the mirror surface region is composed of the central portion 41, the outer edge portion 48, the first outer portions 42 and 43, the second outer portion 45, and the third outer portions 46a, 46b, 47a, and 47b.

According to the second processing example, it is possible to obtain the effect of minimizing the occurrence of the unstable tumble flow TF described in the first processing example. According to the second processing example, the following effect is also expected. That is, high-temperature gas is discharged from the exhaust port. Therefore, the temperature of the exhaust port tends to be higher than that of the intake port. Accordingly, the temperature of the constituent portion of the crown surface 40 near the exhaust port tends to be higher than that of the constituent portion of the crown surface 40 near the intake port. In this respect, in the second processing example, the rough surface region is limited to the second outer portion 44 only. Therefore, it is possible to obtain the effect of the mirror surface processing on the second outer portion 45 while ensuring the effect of the rough surface processing on the second outer portion 44.

### 3-2-3. Processing Example of Outer Edge Portion 48

The outer edge portion 48 includes a portion having a combustion chamber height HCH larger than the predetermined value and a portion having a combustion chamber height HCH equal to or less than the predetermined value. Therefore, the outer edge portion 48 can be considered to be subjected to rough surface processing. However, in the first and second processing examples, it is desirable that the outer edge portion 48 is subjected to mirror surface processing.

The first reason for this is that if the portion of the outer edge portion 48 having the largest combustion chamber height HCH is roughened, the traveling of the flame toward the wall surface (bore wall surface) of the combustion chamber CH may be hindered at this portion. The second reason is that the unburned HC is likely to be generated at the outer edge portion 48. That is, the outer edge portion 48 is close to the bore wall surface having a lower temperature than the central portion 41. Therefore, the unburned HC is likely to be generated at the outer edge portion 48. If the surface roughness is large, the unburned HC is likely to be generated when the fuel enters the uneven surface. For the above reasons, it is desirable that the outer edge portion 48 is subjected to mirror surface processing.

What is claimed is:

1. A spark-ignition internal combustion engine comprising:
a cylinder head; and
a piston, wherein:
a crown surface of the piston includes a central portion, and first outer portions and second outer portions located outside the central portion;
a combustion chamber height indicating a distance between the crown surface and a lower surface of the cylinder head at a top dead center during a compression stroke is higher than a predetermined value in the central portion and the first outer portions, and is equal to or lower than the predetermined value in the second outer portions;
the crown surface is composed of a mirror surface region having a surface roughness of less than 0.05 μm and a rough surface region having a surface roughness of 0.05 μm or more and 2.5 μm or less;
all of the central portion and the first outer portions are included in the mirror surface region; and
at least one of the second outer portions is included in the rough surface region.

2. The spark-ignition internal combustion engine according to claim 1, wherein:
the cylinder head includes an intake port and an exhaust port;
the second outer portions are located on both sides of the central portion in an intake and exhaust direction indicating a direction from the intake port to the exhaust port;
the first outer portions are located on both sides of the central portion in a direction orthogonal to the intake and exhaust direction; and
all of the second outer portions are included in the rough surface region.

3. The spark-ignition internal combustion engine according to claim 1, wherein:
the cylinder head includes an intake port and an exhaust port;
the second outer portions are located on both sides of the central portion in an intake and exhaust direction indicating a direction from the intake port to the exhaust port;
the first outer portions are located on both sides of the central portion in a direction orthogonal to the intake and exhaust direction;
the second outer portion located on an intake port side is included in the rough surface region; and
the second outer portion located on an exhaust port side is included in the mirror surface region.

4. The spark-ignition internal combustion engine according to claim 2, further comprising a tumble flow generating portion that generates a tumble flow in a combustion chamber.

5. The spark-ignition internal combustion engine according to claim 1, wherein the predetermined value is a value in a range of 0.9 mm to 1.5 mm.
